(19) United States
(12) Patent Application Publication
(10) Pub. No.: US 2015/0128379 A1
(43) Pub. Date: May 14, 2015

(54) OVERHEAD DOOR CLOSER

(71) Applicant: DORMA Deutschland GmbH, Ennepetal (DE)

(72) Inventors: Volker BIENEK, Dortmund (DE); Stephan Gosch, Riepsdorf (DE)

(21) Appl. No.: 14/539,083

(22) Filed: Nov. 12, 2014

(30) Foreign Application Priority Data
Nov. 13, 2013 (DE) 102013112453.4

(51) Int. Cl. E05F 1/10

(52) U.S. Cl. CPC E05F 1/105
USPC 16/80

(57) ABSTRACT

An overhead door closer comprising including a housing, an output shaft with a cam disc, which shaft is rotatably movable supported in the housing, a link-plate carriage with two rotatably movable pressure rollers supported in the link-plate carriage, wherein the pressure rollers roll on the cam disc, a piston which is linearly guided in the housing, a piston rod which with one end is connected to the link-plate carriage, and with the other end is connected to the piston, and a closer spring, which, on the side of the piston facing the link-plate carriage, abuts at the piston.

### CROSS REFERENCE TO RELATED APPLICATION

This application is related to and claims the benefit of German Patent Application Number 102013112453.4 filed on 13 Nov. 2013, the contents of which are herein incorporated by reference in their entirety

### TECHNICAL FIELD

The present invention relates to an overhead door operator for actuating a door leaf. Furthermore, a door closer arrangement comprising an overhead door closer is provided.

### BACKGROUND

So-called floor door closers and door drives are to be differentiated from the herein described overhead door closer. The overhead door closer is attached to the door leaf, to the wall or to the casing. The transmission of force of the output shaft of the overhead door closer is realized by means of a lever. If, for example, the overhead door closer is attached to a door leaf, a lever is mounted, which with its one end is connected to the output shaft of the overhead door closer and, with its other end, it is connected to the casing, in particular to a sliding rail at the casing. As an alternative, the overhead door closer can be likewise attached to the wall or to the casing. In this case, the lever transmits the force from the output shaft onto the door leaf. However, floor door closers are installed in the floor, disposed below or next to the door leaf. In this case, a cranked door lever having a carrying function is employed. The axis of rotation of the door leaf is coaxially connected to the output shaft of the floor door closer.

Furthermore, door drives are known, in which the opening and/or the closing direction of the door leaf are/is hydraulically and/or electrically operated. In this case, door drives are to include so-called power-assisted door closers as well, which assist the manual opening operation of the door leaf and/or electrically or hydraulically pretension the closer spring.

### BRIEF SUMMARY

The invention provides an overhead door closer, which is simple and inexpensive in manufacturing and installation, and allows for a reliable and low-maintenance operation.

More specifically, the invention provides an overhead door closer, comprising a housing, an output shaft with a cam disc, which shaft is rotatably movable supported in the housing, and a link-plate carriage. The link-plate carriage has two pressure rollers supported in the link-plate carriage to be rotatable. Said two pressure rollers respectively roll on one side of the cam disc. In relation to the output shaft, the cam disc is an eccentric disc. Thereby, a rotational movement of the output shaft can be transformed, via the cam disc and via the pressure rollers, into a linear movement of the link-plate carriage. In the reversed order, a linear movement of the link-plate carriage can be transformed, via the pressure rollers and via the cam disc, into a rotational movement of the output shaft. Furthermore, a linearly guided piston is provided in the housing. The piston is connected to the link-plate carriage via a piston rod. On account of the connection between the link-plate carriage and the piston by means of the piston rod, the link-plate carriage and the piston always perform the same linear movement. Furthermore, a closer spring is disposed in the housing, which, at the side of the piston facing the link-plate carriage, abuts at the piston. Thus, the closer spring is located between the piston and the output shaft. During an opening operation of the door by a user, the output shaft is entrained into rotation. This circumstance translates into a linear movement of the link- plate carriage, of the piston rod and of the piston. The closer spring is compressed by the piston. Once the user passed the door, the closer spring can relax and thus linearly move the piston, the piston rod and the link-plate carriage in the opposite direction, such that the door leaf is closed via the output shaft.

In the prior art arrangements, the two pressure rollers are normally directly supported in the associated piston. Said pistons in turn are linearly movable in the housing. This disposition is disadvantageous in that the support for the sideways force via said pistons, which receive the pressure rollers, is located very close to the location of introduction of force, namely close to the output shaft. Consequently, in prior art arrangements, the guiding surfaces for said pistons needed to be extremely precise, hard and durable. In the inventive overhead door closer shown herein, the pressure rollers are supported in the link-plate carriage, and the link-plate carriage is connected to the piston via the piston rod. Thereby, the piston, which is located far away from the location of introduction of force, namely the output shaft, can be linearly guided. Having as consequence that the sideways force acting upon the piston is reduced and therefore, it is possible to simplify the configuration of the linear guidance of the piston. According to the invention, it is defined that the closer spring abuts at the side of the piston facing the link-plate carriage. As a result, the closer spring is thus located between the output shaft and the piston, whereby again, depending on the overall dimensioning of the overhead door closer, a certain distance is imposed between the output shaft and the piston, respectively a certain length of the piston rod.

In the inventive overhead door closer, the introduction of force is always realized by a user and also by means of the door drive at the door leaf. Said force is introduced via a lever or an arm assembly onto the output shaft, and an introduction of force from outside the system into the overhead door closer is exclusively realized via said output shaft.

The reduction of sideways force increasing the degree of effectiveness is preferably intended for the construction with link-plate carriage, piston rod and large cover. Thereby, the option of an inexpensive configuration of the housing made from injection-molded parts, among others also from plastic material, is provided. Preferably, the link-plate carriage has no contact at the housing inside.

It is particularly preferred that the overall overhead door closer has only three bearing locations in relation to the housing. The output shaft is rotatably movable supported at two locations in the housing. The third bearing location comprising the linear guidance of the piston within the housing. It is thus preferably provided that the link-plate carriage does not reach contact with the housing and is just guided via at least one of the two pressure rollers and the piston rod, as well as the shaft. Within the link-plate carriage in relation to the cam axis, not to the housing, another guidance of the link-plate carriage is provided in the shape of an oblong hole.

It is particularly and preferably intended that the housing comprises an opening and a cover closing off the opening, wherein the output shaft, at least on one side, is supported in the cover, and wherein the overall link-plate carriage together with the cam disc can be inserted into the housing via the opening. Thus, a complete assembly of the link-plate carriage is realized through the opening. The dimensioning of the opening and of the cover is thus adapted to the link-plate carriage. The link-plate carriage can be assembled outside the housing and inserted through the opening. In this case, it is not question of an opening and a cover at the frontal side of the housing, but it is particularly preferred that the output shaft as well is supported in the cover. Thus, the cover includes a break-through, into which the output shaft is fitted.

Furthermore, it is preferably intended that the housing comprises injection-molded low strength material (e. g. aluminum diecasting, plastic material or zinc diecasting) with inserted metal elements. The housing is thus cost-effective, can be manufactured with no or very little subsequent machining. On account of the reduced loads on the housing based on the inventive mechanical construction, low strength materials can be employed. The metal elements are in particular inserted at the locations at which a precise support of structural parts and/or a wear-resistant frictional contact is required between structural parts. In particular the guiding surface of the piston in the housing is reinforced by inserted metal parts. For this purpose, either a bushing or parallel metal strips are injection-molded into the injection-molded housing. It is in particular preferred that both the base body of the housing and the above described large cover be manufactured from low strength materials. For supporting the output shaft, metal bearing elements can be injection-molded into or subsequently inserted. Furthermore, in particular at the frontal side, hydraulic valves are screwed into the housing. For a defined and secure reception of said valves, valve locating bushings are injection-molded into the housing. Further insert part may be machined subsequently to insertion.

In a further preferred embodiment, it is intended that the closer spring abuts at a shoulder in the housing, wherein said shoulder is positioned between the output shaft and the piston. Thus, the closer spring abuts with one end at the shoulder and with the other end at the piston.

The piston rod is preferably rotatably movable connected to the piston. The connection between the piston rod and the link-plate carriage is formed rigidly. For this purpose, either parts of the link-plate carriage and of the piston rod are manufactured integrally with each other or the piston rod and the link-plate carriage are screwed to each other.

It is particularly and preferably intended that the overall space in the housing, from the link-plate carriage to the piston, is continuous and in particular not interrupted by separating walls. The piston rod is thus not guided through a separating wall, but extends freely from the link-plate carriage as far as to the piston. Also the closer spring is in particular located in this space. The entire housing thus has in particular only two spaces. The one large space extends from the link-plate carriage as far as to the side of the piston facing the link-plate carriage. Another, smaller space may be located on the other side of the piston, which space contains the hydraulic oil for the closing dampening.

For configuring the rigid connection between the link-plate carriage and the piston rod, it is preferred, that the link-plate carriage is manufactured integrally with the piston rod, i. e. in this case, they constitute one structural part that has been jointly manufactured. For designing the integral manufacturing, it is intended that the link-plate carriage comprises at least one carrying element. Both pressure rollers are supported on said carrying element. Said carrying element is preferably integrally manufactured with the piston rod or with a part of the piston rod. As an alternative, the link-plate carriage and the piston rod can be rigidly connected to each other. It is preferred that the link-plate carriage and the piston rod are screwed together. In this case, the axes of the screw connection extend either parallel with regard to the output shaft or perpendicularly to the output shaft.

The cover, by means of which the link-plate carriage is preferably installed, is configured to be particularly large, so that the entire link-plate carriage, including the output shaft, can be inserted via the opening. Furthermore, the opening and the cover are dimensioned such that the screw connection as well, in particular with a screw axis parallel to the output shaft, is accessible for connecting the link-plate carriage and the piston rod via said opening.

Instead of said screw connection having a screw axis parallel to the output shaft, the link-plate carriage may have a threaded bolt extending perpendicularly to the output shaft. In this case, it is as well preferred that the link-plate carriage together with said threaded bolt is installed from the top via said opening. Perpendicularly thereto and via the frontal side opening in the housing, the piston rod along with the piston and with the threaded bolt, which extends perpendicularly to the output shaft, are screwed together.

Furthermore, the invention comprises a door closer arrangement having an above described overhead door closer, a lever and a sliding rail. One end of the lever is torque-proof connected to the output shaft and the other end of the lever is guided to be linearly movable in the sliding rail. The overhead door closer is attached either to a wall, a casing or directly to the door leaf. The advantageous configurations and dependent claims, described in conjunction with the inventive overhead door closer are correspondingly employed advantageously in the inventive door closer arrangement.

### BRIEF DESCRIPTION OF THE DRAWINGS

In the following, several embodiments of the invention will be explained in detail based on the accompanying drawings, in which:

FIG. 1: shows an inventive overhead door closer according to a first embodiment,

FIG. 2: shows a detail of the inventive overhead door closer according to the first embodiment,

FIG. 3: shows the inventive overhead door closer according to the first embodiment in the installed condition,

FIG. 4: shows an inventive overhead door closer according to a second embodiment,

FIG. 5: shows an inventive overhead door closer according to a third embodiment,

FIG. 6: shows an inventive overhead door closer according to a fourth embodiment,

FIG. 7: shows an inventive overhead door closer according to a fifth embodiment.

### DETAILED DESCRIPTION

In the following, five embodiments of an inventive overhead door closer 1 will be explained in detail. The same, respectively functionally identical structural components are identified in all embodiments by the same reference numerals.

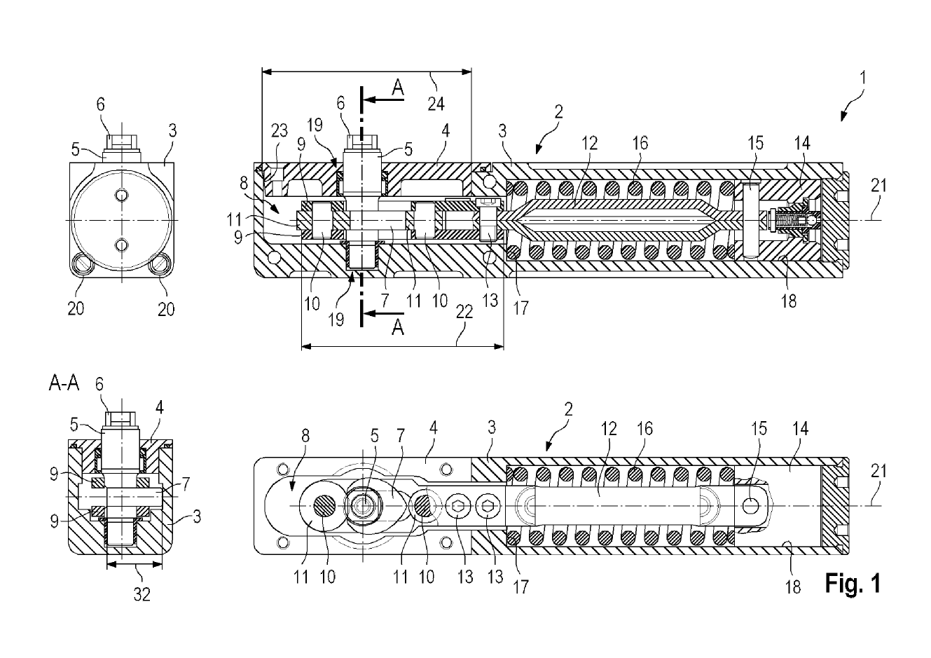

FIG. 1 shows four different views of the overhead door closer 1 according to the first embodiment. The overhead door closer 1 comprises a housing 2 having a base body 3 and a cover 4. The base body 3 and the cover 4 are manufactured in an injection-molding process. An output shaft 5 is rotatably movable supported in the cover 4 and in the base body 3. A polygon 6 is located at one end of the output shaft 5. A lever or an arm assembly can be torque-proof connected to the output shaft via said polygon 6. A cam disc 7 is torque-proof seated on the output shaft 5.

A link-plate carriage 8 is disposed inside the housing 2.

Said link-plate carriage 8 has no direct contact or guidance with regard to the housing 2. The link-plate carriage 8 comprises two parallel carrying elements 9. Two pressure rollers 11 are supported, via pressure roller bolts 10, to be rotatably movable between said two carrying elements 9. Respectively one of the pressure rollers 11 is located on one side of the cam disc 7. The two pressure rollers 11 roll on the cam disc 7.

Furthermore, a piston 14 is guided to be linearly movable in the housing 2. The piston 14 is connected to the link-plate carriage 8 via a piston rod 12. A screw connection 13 is provided as a connection between the piston rod 12 and the link-plate carriage 8 and configured with two individual screws parallel to the output shaft 5. The connection between the piston rod 12 and the piston 14 is realized via a bolt 15. Said connection is rotatably movable with a certain play around the bolt 15. A closer spring 16 is disposed between the piston 14 and a shoulder 17 in the housing 2. The closer spring 16 is configured as a helical spring. With one end the closer spring abuts at the shoulder 17 and with the other end at the piston 14.

A guiding surface 18 is defined in the housing 2. The piston 14 moves on said guiding surface 18. Furthermore, the frontal side view shows, on the left side in FIG. 1, two valve receptions 20. The valve receptions 20 and/or the guiding surfaces 18 can be configured as metal insert elements in the housing 2. The guiding surface 18 is configured for example as a metal bushing or as metal strips extending in the longitudinal direction. FIG. 1 shows furthermore two bearing locations 19 for the rotatable support of the output shaft 5. One of the bearing location 19 is located in the cover 4, the other bearing location 19 is located in the base body 3 of the housing 2. Also said bearing locations may be manufactured as metal insert part during the injection-molding process. As an alternative, it is possible to subsequently insert the elements for said bearing locations 19 into the structural parts, which are manufactured in the injection-molding process.

Furthermore, FIG. 1 shows a longitudinal axis 21 of the overhead door closer 1. The link-plate carriage length 22 is measured along this longitudinal axis 21. Likewise parallel to the longitudinal axis 21, the opening length 24 of an opening 23 is measured. Said opening 23 is closed off by means of a cover 4. The opening length 24 is larger than the link-plate carriage length 22 such that the pre-assembled link-plate carriage 8 can be installed via the opening 23. By employing the cover 4 covering the shaft space, the entire pre-assembled link-plate carriage 8 can be installed into the housing 2, respectively into the base body 3 and can be connected in a bending-resistant manner to the piston rod 12. The entire pre-assembly of the link-plate carriage 8, together with the output shaft 5, allows for a very small structural design and is thus suitable for being employed in overhead door closers, respectively in integral door closers. In a section A-A, FIG. 1 shows a width 32 of the cam disc 7. Finally, said width 32, in conjunction with the required play and a suitable housing walling thickness, pre-determines the overall width of the overhead door closer 1. According to the invention, a very small width 32 is selected in this case such that the overhead door closer 1 can be directly incorporated into the door leaf.

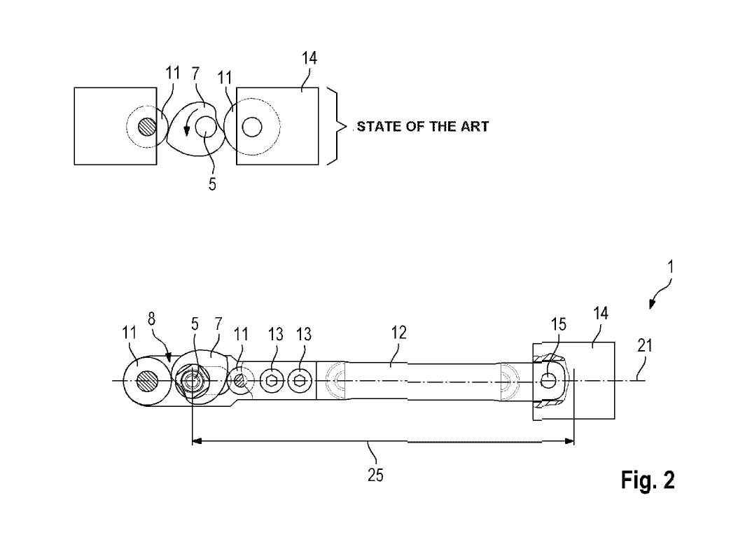

The lower portion of FIG. 2 shows individual structural parts of the overhead door closer 1. The upper illustration of FIG. 2 illustrates individual components of a door closer 1 according to the state-of-the-art. The advantageous embodiment of the inventive overhead door closer 1 will be explained based on the diagrammatic illustration in FIG. 2. The essential feature comprises the large distance of the piston 14 to the location of force introduction, namely the output shaft 5. In this case, measurement is taken from the center of the piston 14 to the center of the output shaft 5. The distance is indicated in

FIG. 2 with the reference numeral 25. However, the illustration according to the state-of-the-art in FIG. 1 shows that the piston 14 with the pressure roller 11 is located significantly closer to the output shaft 5. The overhead door closer shown according to the state-of-the-art shows a piston 14, which with the included pressure roller 11, is directly supported in the housing close to the output shaft 5. This arrangement results in the disadvantage of very high transverse load caused by the small distance of the piston to the location of force introduction, whereby in turn friction and wear is generated.

Resulting in turn in low efficiency. Furthermore, the hydraulic oil is considerably soiled by abrasion, which results in irregularities during the operation times of the door closer.

According to the invention it is thus intended that by means of the mechanical system comprising the link-plate carriage 8 and the piston rod 12, a generation of moments is achieved within the structural parts by means of their multiple functions. In this case, this housing 2 is considerably less exposed to load, which considerably reduces surface pressure, friction, wear and loss of efficiency. This system allows for realizing an inexpensive housing, which can be advantageously manufactured in an injection-molding process. Furthermore, the arrangement of the piston rod screw connection 13 in a row allows for a bending-resistant connection, which requires only a very narrow structural space.

FIG. 2 shows how the transverse load, to be supported by means of the piston 14, can be introduced into the housing, by means of the piston rod 12, far away from the point of introduction of forces. The large lever arm, connected thereto, allows for small supporting forces and thus for a reduced friction and a higher degree of efficiency at the guiding surface 18. Compared to the state-of-the-art, the internal lever system, comprising the piston rod 12 and the link-plate carriage 8, allows for reducing multiple times the support of the sideways force in the housing 2, and thus allows for decreasing friction losses and wear. Moreover, the housing 2 has to assume fewer guiding functions and can thus be manufactured at a reduced cost.

It should be mentioned at this time that, in the overhead door closer 1 shown, the moments of rotation at the output shaft 5, required for controlling the door and the internally occurring forces are considerably lower than the ones for example in a floor door closer. In a floor door closer, the axis of rotation of the door leaf is directly, coaxially connected to the output shaft. However, in the overhead door closer 1, an arm assembly is linked via the polygon 6 such that, in the overhead door closer 1, the ultimate load turns out to be lower. As a consequence, manufacturing the housing 2 of the inventive overhead door closer 1 can be realized at reduced cost, for example from plastic material, zinc diecasting or aluminum diecasting, and it will be sufficient, if for example the guiding surfaces 18 are reinforced by means of metal insert parts. This is in particular possible, because, over the relatively long distance 25, the piston 14 is located far away from the output shaft 5. The embodiment shown is suitable for overhead door closers, in particular for those which are of a very small built and are thus suitable to be incorporated into the door leaf itself. In terms of defining said narrow structure, it is in particular intended that the distance 25 is from 5 times to 10 times the width 32.

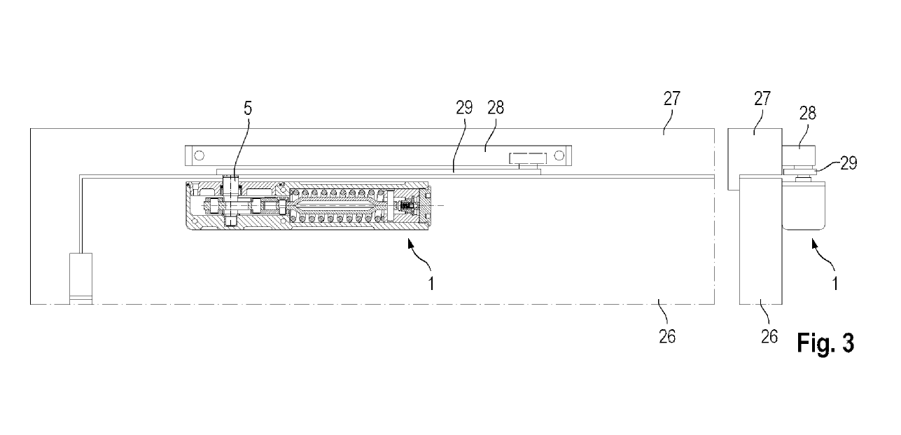

FIG. 3 shows the inventive overhead door 1 closer according to the first embodiment in the installed condition. An entire door closer arrangement can thus be seen in

FIG. 3. The overhead door closer 1 is mounted to the door leaf 26. A sliding rail 28 is located at the casing 27. A lever 29 is torque-proof connected to the output shaft 5. The other end of the lever 29 slides in the sliding rail 28.

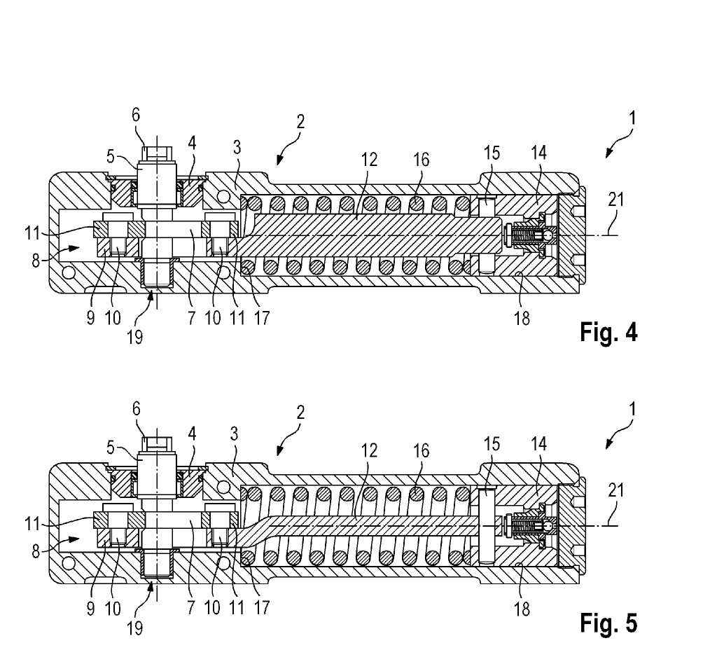

FIG. 4 shows another embodiment of the overhead door closer 1. In this embodiment the link-plate carriage 8 comprises only one carrying element 9. The pressure rollers 11 are supported on said carrying element 9 via the pressure roller bolts 10. The carrying element 9 is integrally manufactured with the piston rod 12. In this case, it is preferably a milled part, which represents both the piston rod 12 and the carrying element 9 of the link-plate carriage 8. In this case, the output shaft 5 together with the cam disc 7 can be subsequently mounted from the top side of the housing. In this case, the housing 4 can be configured considerably smaller, for example as a round part.

FIG. 5 shows a third embodiment of the overhead door closer 1. The single carrying element 9 is integrally manufactured with the piston rod 12 in the third embodiment as well. In this case, it is a common plate bending part, which represents the piston rod 12 and the carrying element 9 of the link-plate carriage 8. In this case again, the output shaft 5 together with the cam disc 7 can be subsequently mounted from the top side of the housing.

In this case, the housing 4 can be configured considerably smaller, for example as a round part.

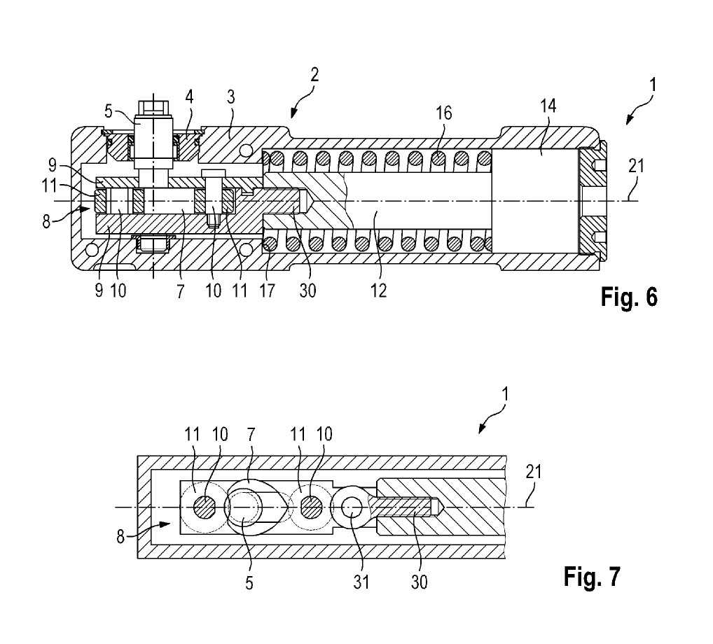

FIG. 6 shows a fourth embodiment of the overhead door closer 1. A threaded bolt 30 is illustrated at the link-plate carriage 8. The threaded bolt 30 extends in the longitudinal direction 21. The piston rod 12 is screwed onto said threaded bolt 30. The piston rod 12 is not illustrated in FIG. 6.

FIG. 7 shows a fifth embodiment of the overhead door closer 1. In the fifth embodiment, the threaded bolt 30 comprises a lug 31. It is via said lug 31, the threaded bolt 30 is connected, in particular screwed to the link-plate carriage 8. The threaded bolt 30 extends in the longitudinal direction 21. The piston rod 12 is screwed onto said threaded bolt 30.

1. An overhead door closer, comprising a housing,
an output shaft with a cam disc, which shaft is rotatably movable supported in the housing,
a link-plate carriage with two pressure rollers which are rotatably movable supported in the link-plate carriage, wherein the pressure rollers roll on the cam disc,
a piston which is linearly guided in the housing,
a piston rod, which is connected to the link-plate carriage with one end and is connected to the piston with the other end, and
a closer spring, which, at the side of the piston facing the link-plate carriage, abuts at the piston.

2. The overhead door closer according to claim 1, wherein the housing comprises an opening and a cover closing the opening, wherein the output shaft is supported in the cover, and wherein the link-plate carriage can be inserted into the housing via said opening.

3. The overhead door closer according to claim 1, herein a distance of the output shaft to the center of the piston and a width of the cam disc, wherein the distance is from 5 times to 10 times the width.

4. The overhead door closer according to claim 1, wherein the housing consists of materials which are suitable for the injection molding process.

5. The overhead door closer according claim 4, wherein a guiding surface for the piston inside the housing is formed by means of an inserted metal bushing or by means of inserted metal strips.

6. The overhead door closer according to claim 1, wherein the link-plate carriage does not get in contact with the housing and is simply guided via the two pressure rollers and the piston rod.

7. The overhead door closer according to claim 1, wherein the closer spring abuts at a shoulder in the housing, wherein the shoulder is positioned between the output shaft and the piston.

8. The overhead door closer according to claim 1, wherein the piston rod is rotatably movable connected to the piston.

9. The overhead door closer according to claim 1, wherein the space in the housing, from the link-plate carriage to the piston, is freely continuous and is in particular not interrupted by separating walls.

10. The overhead door closer according to claim 1, wherein the link-plate carriage is integrally manufactured with the piston rod or is rigidly connected to the piston rod.

11. The overhead door closer according to claim 1, wherein the link-plate carriage comprises at least one carrying element on which both pressure rollers are supported and in that the carrying element is integrally manufactured with the piston rod.

12. The overhead door closer according to claim 1, wherein the link-plate carriage is screwed to the piston rod.

13. The overhead door closer according to claim 12, wherein the axis of the screw connection between the link-plate carriage and the piston rod is disposed vertically or parallel with regard to the output shaft.

14. A door closer arrangement, comprising an overhead door closer according to claim 1, a lever, and a sliding rail, wherein one end of the lever is connected to the output shaft and the other end of the lever is linearly movable guided in the sliding rail.
